(19) United States
(12) Patent Application Publication
(10) Pub. No.: US 2019/0043033 A1
(43) Pub. Date: Feb. 7, 2019

(54) POINT-OF-SALE TERMINAL

(71) Applicant: TOSHIBA TEC KABUSHIKI KAISHA, Tokyo (JP)

(72) Inventors: Ryuichi AOYAMA, Setagaya Tokyo (JP); Tomonori IKUMI, Numazu Shizuoka (JP); Naoki WATANABE, Adachi Tokyo (JP); Masami TAKAHATA, Setagaya Tokyo (JP)

(21) Appl. No.: 16/053,212

(22) Filed: Aug. 2, 2018

(30) Foreign Application Priority Data
Aug. 3, 2017 (JP) 2017-150503

(51) Int. Cl. G06Q 20/20; G06K 7/14

(52) U.S. Cl. CPC G06Q 20/208; G06K 7/1413

(57) ABSTRACT

A point-of-sale terminal includes a storage device that stores, in association for each of a plurality of commodities that may be registered, a commodity code unique to the commodity, a commodity name, a price of the commodity, and a commodity classification to which the commodity belongs. An input device receives input of a commodity classification and a price of the commodity. A processor is programmed to perform a category-based commodity registration processing including: searching the storage device based on the commodity classification and the price input via the input device, determining at least one candidate commodity based on the search, and registering the commodity based on the commodity code stored in association of a selected one of the at least one determined candidate commodities. The processor settles the transaction based on the price associated with each commodity code of the commodity registered.

### CROSS-REFERENCE TO RELATED APPLICATION

This application is based upon and claims the benefit of priority from Japanese Patent Application No. 2017-150503, filed Aug. 3, 2017, the entire contents of which are incorporated herein by reference.

### FIELD

Embodiments described herein relate generally to a commodity registration device and a commodity registration method.

### BACKGROUND

Methods of registering commodity sales data in a commodity registration device such as point of sales (POS) terminal include a price lookup (PLU) registration and a category registration. In the PLU registration, for example, a barcode on a commodity is read by a scanner. Then, a commodity name, a price, and the like are determined by searching a database using a commodity code specified by the barcode, and thus, the commodity code, the commodity name, the price, and the like are sales-registered. In the category registration, for example, a category code of a category to which the commodity belongs and a price are input via a keyboard. Then, a category name is determined by searching a database using the input category code, and thus, the category code, the category name, the price, and the like are sales-registered. Incidentally, the category is an identification name of a commodity classification in which each of the commodity items having a similar attribute is classified.

In recent years, barcodes are attached to many commodities, and the sales data is registered for the commodity registration device using the PLU registration. By performing the PLU registration, there is an advantage that the sales data of each commodity can be managed on an item basis. However, in some commodities such as fresh fish, fruits, vegetables, and the like, the barcode is not attached thereto, and thus, the category registration is required. If the category registration is performed, the sales data of those specific commodities are not reflected on the sales data.

### DESCRIPTION OF THE DRAWINGS

FIG. 1 is a block diagram illustrating a configuration of a POS terminal according to an embodiment.

FIG. 2 illustrates an example of a key layout arranged on a keyboard of the POS terminal.

FIG. 3 illustrates a data structure of commodity records stored in a commodity master.

FIG. 4 illustrates a data structure of category records stored in a category master.

FIG. 5 illustrates a data structure of recognition dictionary records stored in a recognition dictionary master.

FIG. 6 illustrates a data structure of history records stored in a purchase history master.

FIG. 7 illustrates data structures a transaction memory and a candidate memory formed in a main memory of the POS terminal.

FIG. 8 is a flowchart illustrating an information processing procedure performed by a processor of the POS terminal according to a commodity registration program.

FIG. 9 is a flowchart illustrating a commodity estimation processing procedure in FIG. 8.

FIG. 10 is a flowchart illustrating a candidate narrow-down processing procedure in FIG. 9.

FIG. 11 illustrates a display example of a selection screen.

FIG. 12 illustrates an example of issuing a receipt. FIG. 13 illustrates a data structure in a candidate memory formed in a main memory of the POS terminal according to a second embodiment.

FIG. 14 is a flowchart illustrating a candidate narrow-down processing procedure performed by a processor of the POS terminal according to a commodity registration program in the second embodiment.

FIG. 15 illustrates a display example of a selection screen in the second embodiment.

### DETAILED DESCRIPTION

Embodiments provide a point-of-sale terminal and a commodity registration method that can reflect sales data of specific commodities registered by inputting a commodity category and a price.

A point-of-sale terminal according to an embodiment includes a storage device that stores, in association for each of a plurality of commodities that maybe registered, a commodity code unique to the commodity, a commodity name, a price of the commodity, and a commodity classification to which the commodity belongs. An input device receives input of a commodity classification to which a commodity to be registered in a transaction belongs and a price of the commodity. A processor is programmed to perform a category-based commodity registration processing including: searching the storage device based on the commodity classification and the price input via the input device, determining at least one candidate commodity based on the search, and registering the commodity to be registered in the transaction based on the commodity code stored in association of a selected one of the at least one determined candidate commodities. The processor performs a settlement processing to settle the transaction based on the price associated with each commodity code of the commodity registered in connection with the transaction.

Embodiments of a point-of-sale terminal capable of reflecting sales data of specific commodities registered by inputting commodity classifications and prices will be described below with reference to the drawings.

### First Embodiment

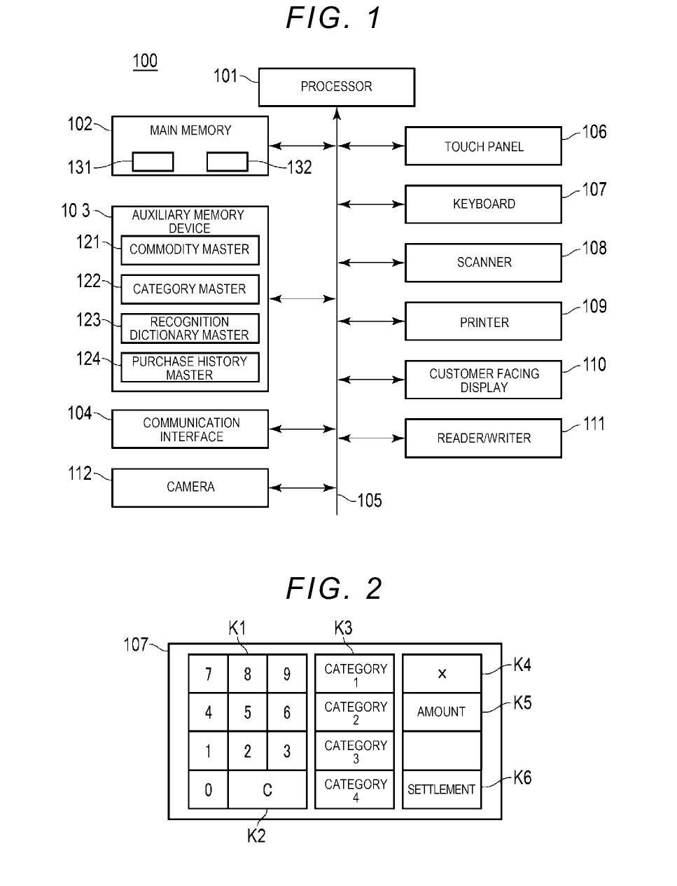

First, a configuration of the POS terminal 100 will be described with reference to FIGS. 1 to 7. FIG. 1 is a block diagram illustrating a configuration of the POS terminal 100. The POS terminal 100 includes a processor 101, a main memory 102, an auxiliary memory device 103 and a communication interface 104. The POS terminal 100 functions as a computer with the processor 101, the main memory 102, the auxiliary memory device 103, and the communication interface 104 connected via a system bus 105.

The processor 101 corresponds to a central processor of the computer. The processor 101 controls each component to realize various functions of the POS terminal 100 according to an operating system and an application program.

The main memory 102 corresponds to a main memory portion of the computer. The main memory 102 includes a nonvolatile memory area and a volatile memory area. The operating system and the application programs are stored in the nonvolatile memory area of the main memory 102. In addition, in the main memory 102, sometimes data necessary for the processor 101 to perform processing for controlling each unit is stored in the nonvolatile or the volatile memory region. The main memory 102 uses the volatile memory area as a work area where the processor 101 appropriately rewrites the data.

The auxiliary memory device 103 corresponds to an auxiliary storage portion of the computer. For example, a hard disc drive (HDD), a solid state drive (SSD), an electric erasable programmable read-only memory (EEPROM), and the like are used as the auxiliary memory device 103. Data used by the processor 101 for performing various processing items or data generated by processing performed by the processor 101 are stored in the auxiliary memory device 103. Sometimes the auxiliary memory device 103 stores the application program described above.

The communication interface 104 performs data communication with a store server connected via a network such as LAN according to a communication protocol set in advance. The store server communicates with the POS terminals 100 in the store via the network. The store server has a function of aggregating data representing the sales of each commodity in an item basis or in a category basis based on transaction data collected from each POS terminal 100 via the network. Such a store server is a well known server, and thus, the description thereof will be omitted.

The system bus 105 includes an address bus, a data bus, a control signal line, and the like. The POS terminal 100 connects various input/output devices to the computer via the system bus 105. The input/output device includes a touch panel 106, a keyboard 107, a scanner 108, a printer 109, a customer facing display 110, a reader/writer 111, a camera 112, and the like.

The touch panel 106 displays an information providing screen to an operator. In addition, the touch panel 106 functions as an input device for a touching operation by the operator.

The keyboard 107 has various keys necessary for the commodity registration. An example of the keys necessary for the commodity registration is illustrated in FIG. 2. As illustrated, a numeric key (ten key) K1, a clear key K2, a plurality of (four in FIG. 2) category keys K3, a multiplication key K4, an amount key K5, a settlement key K6, and the like are arranged on the keyboard 107.

The numeric key K1 is a key for inputting numerical data such as commodity prices, deposit amounts from customers, and the like. The clear key K2 is a key for instruction to clear the numerical data input by the numeric key K1. The category key K3 is a key for inputting the commodity classification, that is, a so-called category, in which each commodity is classified by its attribute. To the plurality of category keys K3, category codes for specifying different categories are assigned. The multiplication key K4 is a key for indicating that a numerical value input by the numeric key K1 is a multiplier. The amount key K5 is a key for indicating that the numerical value input by the numeric key K1 is an amount of money. The settlement key K6 is a key for indicating that a commercial transaction is settled. In general, a settlement of the commercial transaction includes a cash settlement, a credit settlement, a cash voucher settlement, and the like. The cash settlement means the settlement of the commercial transaction by cash payment. The credit settlement means the settlement of the commercial transaction by a credit card. The cash voucher settlement means the settlement of the commercial transaction by a cash voucher such as a gift certificate. Usually, settlement keys are prepared for each type of settlement in the keyboard 107. However, in this embodiment, since the type of the settlement is not important, the description will be made with one settlement key K6.

The scanner 108 scans and reads barcodes. The scanner 108 may be a stationary scanner or may be a hand-held scanner. The barcode that can be read by the scanner 108 is not limited to a single-level barcode. For example, the scanner 108 can read a two-level barcode, a two-dimensional barcode (or two-dimensional data code) and the like.

The printer 109 prints receipt data on a receipt form and issues a receipt. The printer 109 can print data other than the receipt data on the receipt form. The POS terminal 100 may be provided with a so-called electronic receipt system that provides the receipt data to the customers as electronic data.

The customer facing display 110 displays the information providing screen toward the customer. The name of the commodity purchased by the customer, the price, and the like are displayed on the customer facing display 110. In addition, the total amount of money for the commodities purchased by the customer is also displayed. A touch panel may be used as the customer facing display 110.

The reader/writer 111 reads and writes data on a card medium such as a membership card, a point card, a credit card, and the like. If the card medium is a magnetic card, the reader/writer 111 is a magnetic card reader/writer. If the card medium is an IC card, the reader/writer 111 is an IC card reader/writer. The IC card reader/writer may be a contact type or a non-contact type reader/writer. If the magnetic card and the IC card are used in a mixed manner, the POS terminal 100 includes the magnetic card reader/writer and the IC card reader/writer. If writing to the card is unnecessary, a dedicated card reader may be used.

The camera 112 is used for taking a picture of a commodity on which a barcode is not attached. The camera 112 includes, for example, a charge coupled device sensor (CCD). The operator puts the commodity over an imaging area of the camera 112, and then, an image of the commodity is acquired by the POS terminal 100.

The POS terminal 100 having such a configuration allocates parts of the storage area of the auxiliary memory device 103 as areas of a commodity master 121, a category master 122, a recognition dictionary master 123, and a purchase history master 124.

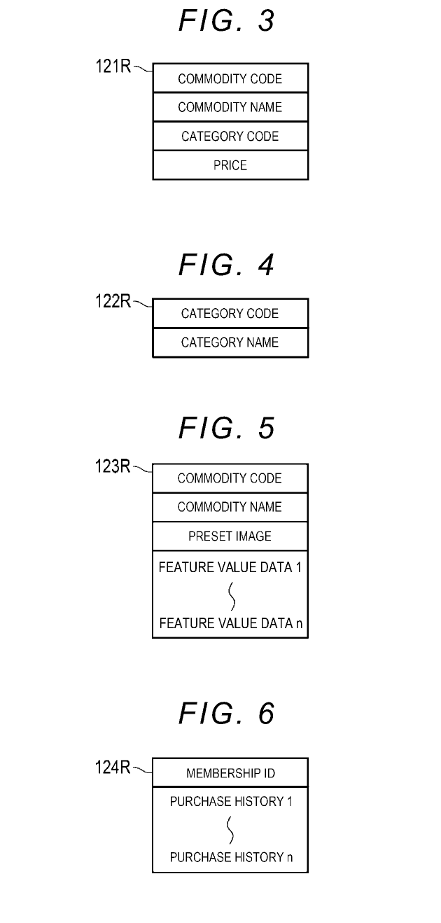

The commodity master 121 stores various data relating to commodity items. An example of data records for each commodity stored in the commodity master 121 is illustrated in FIG. 3. As illustrated, the commodity master 121 stores commodity records 121R including the commodity code, the commodity name, the category code, the price, and the like for each of the commodity items. That is, the commodity master 121 stores the commodity records 121R including not only for commodities on which the barcode is attached but also for the commodities on which the barcode is not attached. The commodity code is a unique code for specifying each commodity. The barcode attached on the commodity is a barcode of the commodity code. The commodity name is an item name of the commodity specified by the commodity code. The category code is a code of the category to which the commodity specified by the commodity code belongs. The price is a price (a unit price) per a unit quantity of the commodity specified by the commodity code. Here, the commodity master functions as a commodity storage unit.

The category master 122 stores various data items relating to the category which includes similar items (commodity classification). An example of the data record of one category stored in the category master 122 is illustrated in FIG. 4. As illustrated, the category master 122 stores category records 122R including the category code and a category name. The category code is a code uniquely assigned to each category to identify each category. The category name is a generic name for the category specified by the category code. Here, the category master 122 functions as a classification storage unit.

The recognition dictionary master 123 stores feature value data necessary for image recognition of the commodity. An example of the data record for each commodity stored in the recognition dictionary master 123 is illustrated in FIG. 5. As illustrated, the recognition dictionary master 123 stores recognition dictionary records 123R including the commodity code and the commodity name, a preset image, and a multiple number of feature value data items. The preset image is an image representing the commodity specified by the corresponding commodity code. The feature value data are parameters that represent appearance features (appearance shape, hue, pattern, irregularity degree, and the like) of the commodity specified by the corresponding commodity code. Here, the recognition dictionary master 123 functions as a feature value storage unit.

The purchase history master 124 stores data relating to purchase histories of members. An example of the data code for each member stored in the purchase history master 124 is illustrated in FIG. 6. As illustrated, the purchase history master 124 stores history records 124R including a membership ID and a multiple number of purchase history data items. The membership ID is a unique code assigned to each member for identifying the member. The member owns a membership card in which the membership ID is recorded. Alternatively, the member owns an information terminal storing an application program for displaying a barcode of the membership ID on the screen. The information terminal is, for example, a smartphone, a tablet terminal, or the like. The purchase history data includes purchase date and time, the code, the name, the price and the quantity of, and the amount of money for each purchased commodity. If the commodity is registered on the PLU registration basis, the code is the commodity code, and if the commodity is registered on the category registration basis, the code is the category code. If the commodity is registered on the PLU registration basis, the name is the commodity name, and if the commodity is registered on the category registration basis, the name is the category name. If the commodity is registered on the PLU registration basis, the category code of the category to which the commodity belongs is also stored in the purchase history data. Here, the purchase history master 124 functions as a history storage unit.

In addition, in the POS terminal 100, a transaction memory 131 and a candidate memory 132 are formed in the volatile area of the main memory 102.

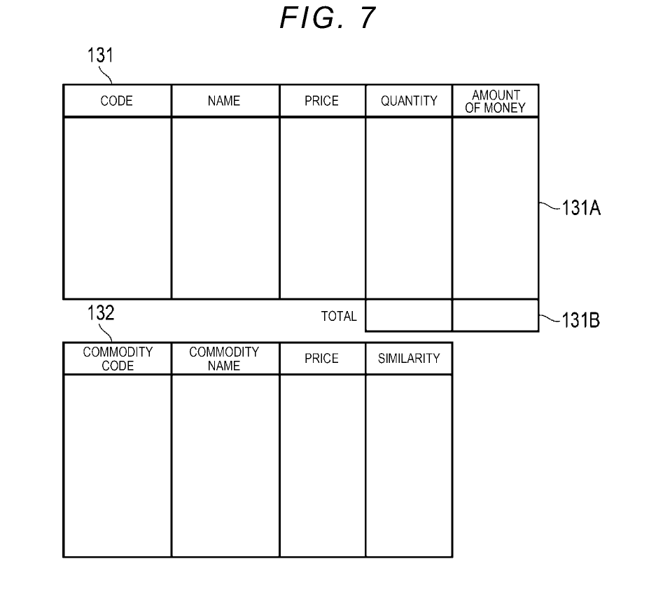

FIG. 7 illustrates data structures of the data in the transaction memory 131 and the candidate memory 132. The transaction memory 131 includes a list area 131A for storing the code, the name, the price, the quantity of and the amount of money for each purchased commodity of one commercial transaction in association with each other, and a total area 131B of the quantities and the amount of money. The candidate memory 132 includes an area for storing the commodity code, commodity name, price and similarity of the candidate commodities in association with each other. The candidate commodity and the similarity will be described later.

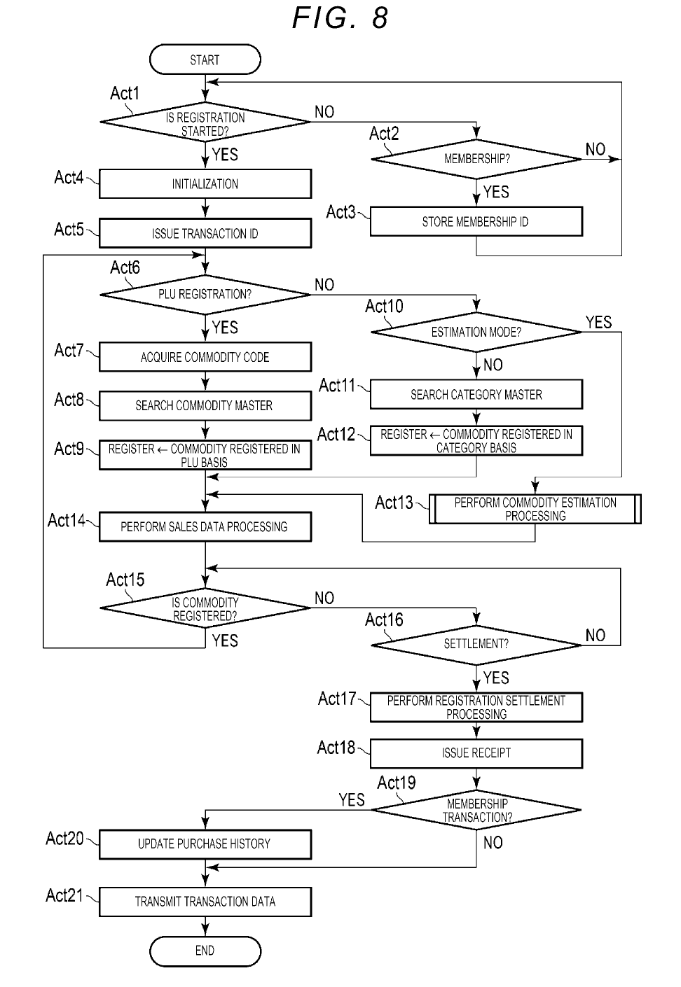

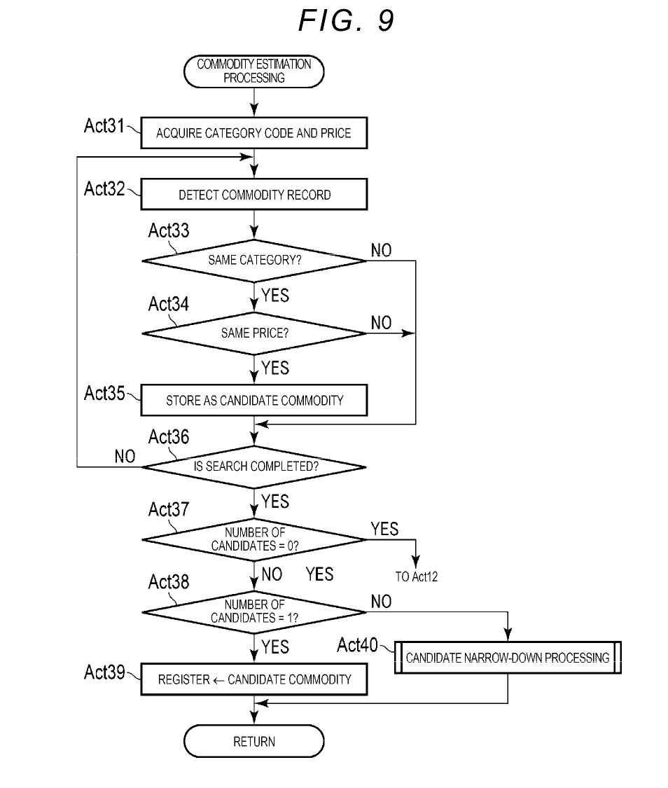

Next, an operation of the POS terminal 100 will be described with reference to FIG. 8 to FIG. 12.

FIG. 8 to FIG. 10 are flowcharts illustrating an information processing procedure performed by the processor 101 of the POS terminal 100 according to a commodity registration program. The commodity registration program is a type of application program stored in the main memory 102 or the auxiliary memory device 103. The content items of the processing illustrated in FIG. 8 to FIG. 10 and described below are mere examples. The processing procedures and processing content items are not particularly limited as long as similar results can be obtained.

In the present embodiment, it is assumed that the store is a retail store in which a commodity sales floor and an accounting place (a cash register) are separated from each other. In such a store, the customer gathers the commodities to be purchased around the sales floor and finally goes to the accounting place and performs the accounting. The POS terminal 100 is installed at the accounting place, and a clerk, that is, a so-called cashier, is an operator.

When the customer comes to the accounting place, the cashier first asks whether or not the customer has a membership with respect to the store, for example, a point membership. If the customer has the membership, the cashier inputs the customer's membership ID to the POS terminal 100. For example, if the customer presents a membership card, the data of the membership card is read by the reader/writer 111. For example, if the customer presents an information terminal displaying the barcode of the membership card, the barcode is read by the scanner 108.

Next, the cashier registers the commodities that the customer purchases. That is, for the commodities on which the barcode is attached, the cashier performs a PLU registration by causing the scanner 108 to read the barcode of the commodity. On the other hand, for the commodities on which the barcode is not attached or for example, the barcode is obscured and could not be read, the cashier performs a category registration by operating the keyboard 107 and inputting the category code of the category to which the commodity belongs and the prices.

In order to respond to such operations, as Act 1 in FIG. 8, the processor 101 of the POS terminal 100 determines whether or not the commodity registration is started. If the commodity registration is not started (NO in Act 1), as Act 2, the processor 101 determines whether or not the membership ID is input. If the membership ID is not input (NO in Act 2), the processor 101 determines again whether or not the commodity registration is started. Here, the processor 101 waits for starting of the commodity registration or inputting of the membership ID by the processing items in Act 1 and Act 2.

As described above, when the reader/writer 111 reads the data of the membership card or the scanner 108 reads the barcode of membership card, the processor 101 regards that the membership ID is input (YES in Act 2). As Act 3, the processor 101 stores the input membership ID into a membership ID memory. The membership ID memory is a part of the work area allocated in the main memory 102. Thereafter, the processor 101 determines again whether or not the commodity registration is started.

When the barcode attached on the commodity is read by the scanner 108 or the category code of the category to which the commodity belongs and the price of the commodity are input via the keyboard 107, the processor 101 determines that the commodity registration is started (YES in Act 1). As Act 4, the processor 101 performs initialization. The transaction memory 131 and the candidate memory 132 are cleared by this initialization. As Act 5, the processor 101 issues a unique transaction ID and writes the transaction ID into a transaction ID memory. The transaction ID memory is a part of the work area allocated in the main memory 102.

As Act 6, the processor 101 determines whether the commodity registration is the PLU registration or the category registration. If the scanner 108 reads the barcode of the commodity, the processor 101 determines that the commodity registration is the PLU registration (YES in Act 6). As Act 7, the processor 101 analyzes the barcode to acquire the commodity code. As Act 8, the processor 101 searches the commodity master 121, i.e., the commodity records 121R including the commodity code acquired in Act 7. As Act 9, the processor 101 acquires the commodity name and the price from the commodity records 121R, and stores the commodity code, the commodity name and the price into a registration memory. In other words, the processor 101 stores the commodity code, the commodity name and the price of the commodity registered in the PLU basis into the registration memory. The registration memory is a part of the work area allocated in the main memory 102. Thereafter, the processor 101 makes the process proceed to the processing in Act 14.

In Act 6, if the category code and the price are input from the keyboard 107, the processor 101 determines that the commodity registration is the category registration basis (NO in Act 6). As Act 10, the processor 101 checks whether or not an estimation mode is valid. The estimation mode is a mode in which commodity estimation processing is performed for commodities registered according to the category registration basis. The commodity estimation processing is processing for estimating the commodity items that are registered according to the category registration basis. In the POS terminal 100, an option flag for setting the estimation mode as valid or invalid is stored in the auxiliary memory device 103. This option flag is set to be valid or invalid in a setting operation of the POS terminal. For example, in a store which is operated with performing the commodity estimation processing, the option flag is set to be valid state in advance. For example, in a store which is operated without performing the commodity estimation processing, the option flag is set to be invalid state in advance.

If the estimation mode is invalid, that is, if the option flag is set to be the invalid state (No in Act 10), the processor 101 searches the category master 122 as Act 11 and reads the category record 122R including the category code input via the keyboard 107. As Act 12, the processor 101 acquires the category name from the category records 122R and further acquires the price input via the keyboard 107, and then, writes the category code, the category name and the price into the registration memory. That is, the processor 101 writes the category code, the category name, and the price of the commodity registered according to the category registration basis into the registration memory. Thereafter, the processor 101 makes the process proceed to Act 14.

If the estimation mode is valid, that is, if the option flag is set to be the valid state (YES in Act 10), the processor 101 performs the commodity estimation processing as Act 13.

FIG. 9 is a flowchart illustrating the commodity estimation processing. When entering the commodity estimation processing, as Act 31, the processor 101 acquires the category code and the price input via the keyboard 107 at the time of category registration, and writes the category code and the price into a comparison memory. The comparison memory is a part of the work area allocated in the main memory 102.

As Act 32, the processor 101 searches the commodity master 121 and detects one commodity record 121R. The processor 101 determines whether or not the category code of the detected commodity record 121R matches the category code stored in the comparison memory. If the category codes do not match each other (NO in Act 33), the processor 101 makes the process proceed to Act 36.

If the category codes match each other (YES in Act 33), as Act 34, the processor 101 determines whether or not the price of the detected commodity record 121R matches the price stored in the comparison memory. If the prices do not match each other (NO in Act 34), the processor 101 makes the process proceed to Act 36.

If the prices match each other (YES in Act 34), as Act 35, the processor 101 sets the commodity specified by the commodity record of which the category code and the price match the data in the comparison memory as the candidate commodity. That is, the processor 101 stores the commodity code, the commodity name and the price included in the commodity record into the candidate memory 132 in association with a similarity of a default value. The default value of the similarity is, for example, “0”. Thereafter, the processor 101 proceeds to Act 36.

In Act 36, the processor 101 determines whether or not the search of the commodity master 121 is completed. If the commodity records 121R still remain undetected in the commodity master 121, the search of the commodity master 121 is not completed. If the search of the commodity master 121 is not completed (NO in Act 36), the processor 101 returns the process to Act 32. That is, the processor 101 detects one commodity record 121R from the undetected commodity records 121R, and performs the processing items in Act 33 to Act 35 in the same manner as described above.

Here, the processor 101 functions as a searching means by performing the processing items in Act 31 to Act 36.

When all of the commodity records 121R stored in the commodity master 121 are sequentially searched and the processing items in Act 33 to Act 35 are performed to the end, the processor 101 recognizes that the search of the commodity master 121 is completed. When the search of the commodity master 121 is completed (YES in Act 36), as Act 37, the processor 101 determines whether or not the number of candidates is “0”. If no data is stored in the candidate memory 132, the number of candidates is “0”. If the number of candidates is “0” (YES in Act 37), the processor 101 proceeds to the processing in Act 12 in FIG. 8. That is, the processor 101 searches the category master 122 and reads the category records 122R including the category code stored in the comparison memory. The processor 101 acquires the category name from the category records 122R, further acquires the price stored in the comparison memory, and writes the category code, the category name and the price into the registration memory.

If the data is stored in the candidate memory 132, the number of candidates is not “0”. If the number of candidates is not “0” (NO in Act 37), as Act 38, the processor 101 determines whether or not the number of candidates is “1”. If only one data item is stored in the candidate memory 132, the number of candidates is “1”. If the number of candidates is “1” (YES in Act 38), as Act 39, the processor 101 writes the commodity code, the commodity name and the price of the one data item stored in the candidate memory 132 into the registration memory. That is, the processor 101 writes the commodity code, the commodity name and the price of the only one candidate commodity searched in the commodity estimation processing into the registration memory.

If two or more of data items are stored in the candidate memory 132, that is, if the number of candidates is neither “0” nor “1” (NO in both Act 37 and Act 38), as Act 40, the processor 101 performs candidate narrow-down processing.

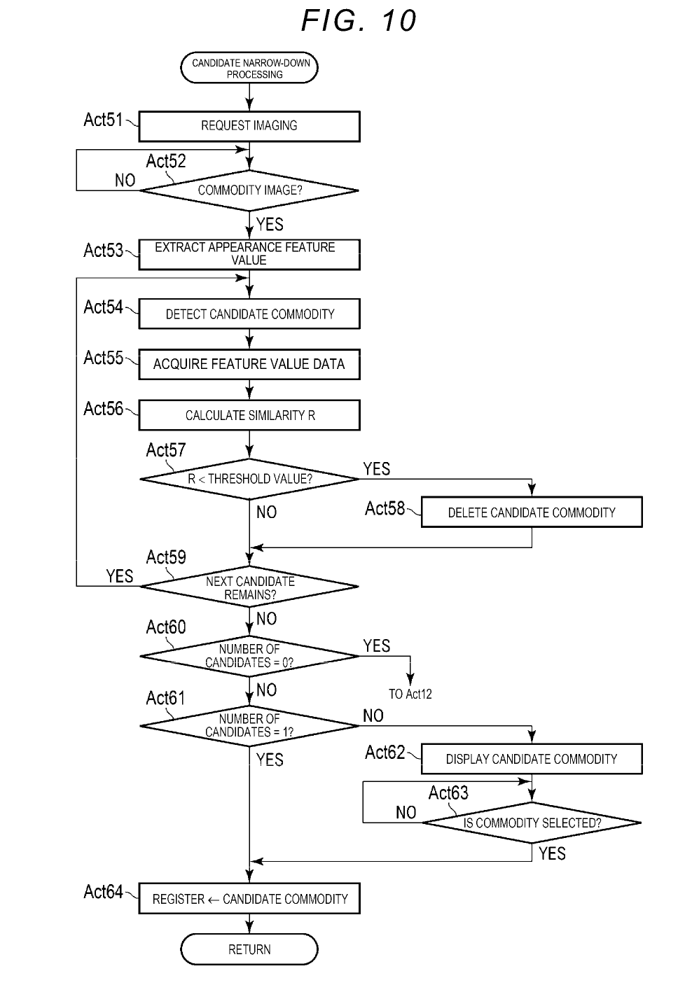

FIG. 10 is a flowchart illustrating the candidate narrow-down processing. When entering the candidate narrow-down processing, as Act 51, the processor 101 causes the touch panel 106 to display a message requesting the cashier to capture an image the commodity, for example, “Please put the commodity registered in the category registration basis over the camera”. After confirming this message, the cashier puts the commodity to which the category code and the price were input just before (by operating the keyboard 107) over the imaging area of the camera 112. By putting the commodity over the imaging area of the camera 112, the image of the commodity is generated by the camera 112. Frame images sequentially generated by the camera 112 are sequentially stored in an image memory of the main memory 102.

As Act 52, the processor 101 checks whether or not the commodity is imaged in the frame image stored in the image memory. If the commodity is not imaged in the frame image (NO in Act 52), the processor 101 retrieves the next frame image from the image memory. The processor 101 checks whether or not the commodity is imaged in the next frame image.

As a result of sequentially checking the frame images stored in the image memory as described above, if a frame image in which the commodity is imaged is detected (YES in ACT 52), as Act 53, the processor 101 detects an outline of the commodity from the frame image and extracts an image within the outline. The processor 101 extracts the appearance feature value of the commodity such as the shape, the hue of a surface, the pattern, the unevenness situation, or the like from the extracted image, that is, from the image of the commodity.

If the appearance feature value of the commodity can be extracted, as Act 54, the processor 101 detects one commodity code from the candidate commodity data stored in the candidate memory 132. As ACT 55, the processor 101 searches the recognition dictionary master 123 and acquires the feature value data stored in association with the commodity code.

As Act 56, the similarity R indicating a degree of similarity between the feature value data extracted from the commodity image in the processing in Act 53 and each feature value data acquired from the recognition dictionary master 123 in the processing in Act 55, is calculated by the processor 101. The processor 101 rewrites the similarity stored in the candidate memory 132 in association with the commodity code with the calculated similarity R. The similarity R is calculated within the range of “0” to “100” according to the Hamming distance, for example, and has a larger value as the ratio similarity is higher.

As Act 57, the processor 101 determines whether or not the similarity R is smaller than a predetermined threshold value. A commodity whose similarity R is smaller than the predetermined threshold value is excluded from the candidate for the commodity registered in the category registration basis. If the similarity R is smaller than the threshold value (YES in Act 57), as Act 58, the processor 101 deletes the commodity code and each data of the commodity name, the price and the similarity associated with the commodity code from the candidate memory 132. If the similarity R is equal to or greater than the threshold value (YES in Act 57), the processor 101 does not perform the processing in Act 58.

Thereafter, as Act 59, the processor 101 checks whether or not there remain the commodity codes that are not detected yet in the candidate memory 132. If there remain undetected commodity codes (YES in Act 59), the processor 101 returns the process to Act 54. That is, the processor 101 detects one undetected commodity code from the candidate commodity data stored in the candidate memory 132. The processor 101 performs the processing items of Act 55 to Act 58 in the same manner as described above.

In Act 59, if it is determined that there is no undetected commodity code in the candidate memory 132 (NO in Act 59), as Act 60, the processor 101 determines whether or not the number of candidates is “0”. If no data is stored in the candidate memory 132, the number of candidates is “0”. If the number of candidates is “0” (YES in Act 60), the processor 101 proceeds to the processing in Act 12 in FIG. 8. That is, the processor 101 searches the category master 122 and reads each category record 122R including the category code stored in the comparison memory. Then, the processor 101 acquires the category name from the category record 122R, further acquires the price stored in the comparison memory, and then, writes the category code, the category name and the price into the registration memory.

If the data is stored in the candidate memory 132, the number of candidates is not “0”. If the number of candidates is not “0” (NO in Act 60), as Act 61, the processor 101 determines whether or not the number of candidates is “1”. If only one data item is stored in the candidate memory 132, the number of candidates is “1”. If the number of candidates is “1” (YES in Act 61), as Act 64, the processor 101 writes the commodity code, the commodity name and the price of the only one data item stored in the candidate memory 132 into the registration memory. That is, the processor 101 writes the commodity code, the commodity name and the price of the candidate commodity which is narrowed down to one in the commodity narrow-down processing into the registration memory.

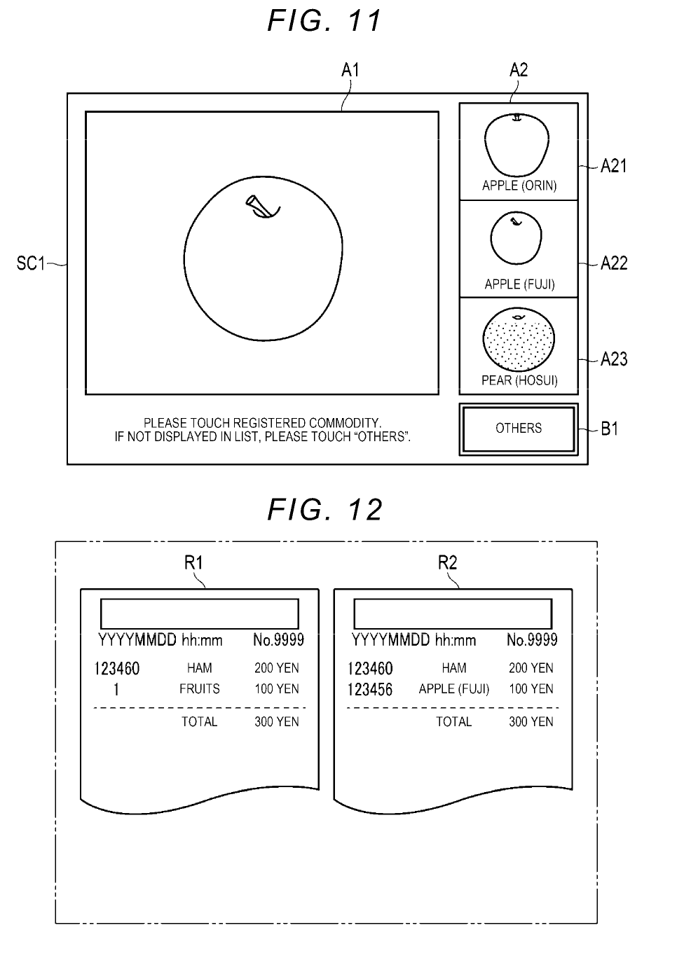

If two or more data items are stored in the candidate memory 132, that is, if the number of candidates is neither “0” nor “1” (NO in both Act 60 and Act 61), as Act 62, the processor 101 causes the touch panel 106 to display a selection screen SC1 (refer to FIG. 11) of the candidate commodity based on the data stored in the candidate memory 132.

An example of the selection screen SC1 is illustrated in FIG. 11. As illustrated, the selection screen SC1 is divided into a display area A1 for the image and a display area A2 for the candidate commodity. In addition, a button B1 for “others” is displayed on the selection screen SC1. In the display area A1, an image of the commodity extracted from the image captured by the camera 112 is displayed. The display area A2 is further subdivided into three areas A21, A22, and A23 in the vertical direction of the screen, preset images of the candidate commodity and the commodity name are displayed from the upper area A21 in a descending order of the similarity. The candidate commodity is the commodity specified by the commodity code stored in the candidate memory 132. The preset image and the commodity name are stored in the recognition dictionary master 123. The processor 101 searches the recognition dictionary master 123 with the commodity code stored in the candidate memory 132, reads the preset image and the commodity name from the recognition dictionary records 123R in which the commodity code is included, and displays the result in the area A2.

Incidentally, in the display area A2 on the selection screen SC1 that is displayed initially in the process of Act 62, the preset images and the commodity names of the candidate commodities are displayed from the top of the screen in an order of the similarity ranging from the first to third. In this state, when the button B1 for “others” is touched, the display area A2 is switched to the preset images and the commodity names of the commodities of which the similarity is ranging from the fourth to sixth. Thereafter, every time the button B1 for “others” is touched, the displayed image in the display area A2 is switched to the preset images and the commodity names of the commodities having the similarity of lower order, and when the preset images and the commodity names of the commodities are displayed to the lowest order, the display returns to the first order.

The cashier checks the selection screen SC1 searches the display area A2 for finding the area A21, A22 or A23 in which the preset image and the commodity name of the commodity which is placed over the imaging area of the camera 112 are displayed. If the relevant area A21, A22 or A23 is found, the cashier touches that area A21, A22 or A23.

As Act 63, the processor 101 waits for the operation of touching the area A21, A22 or A23. If the touching operation is performed on the area A21, A22 or A23, as Act 64, the processor 101 writes the commodity code, the commodity name and the price of the commodity of which the preset image and the like are displayed in the area A21, A22 or A23 into the registration memory. The commodity name and the price are the data stored in the candidate memory 132 in association with the commodity code. That is, the processor 101 writes the commodity code, the commodity name and the price of the candidate commodity selected from a plurality of candidate commodities into the registration memory. As above, the processor 101 ends the candidate narrow-down processing.

Here, the processor 101 functions as a determination means by performing the processing items in Act 39, Act 40 and Act 41 in FIG. 9. In addition, the processor 101 functions as a narrow-down means included in the determination means by performing processing items in Act 51 to Act 59 in FIG. 10.

When the data of the commodity code, the commodity name and the price are written into the registration memory by performing the processing in Act 39 in FIG. 9 or the processing in Act 64 in FIG. 10, the commodity estimation processing ends. When the commodity estimation processing ends, the processor 101 makes the process proceed to Act 14 in FIG. 8.

In Act 14, the processor 101 performs sales data processing. That is, the processor 101 multiplies the price stored in the registration memory by the sales quantity to calculate the amount of money. The sales quantity is the multiplier if the multiplier is input by inputting the numeric key K1 and the multiplication key K4, and is “1” if the multiplier is not input. The processor 101 associates the code (the commodity code or the category code), the name (the commodity name or the category name), and the price stored in the registration memory with the sales quantity and the amount of money respectively, and stores the result in the list area 131A of the transaction memory 131. In addition, the processor 101 updates the data in the total area 131B of the transaction memory 131. Furthermore, the processor 101 displays the name (the commodity name or the category name), the price, and the sales quantity and the amount of money on the touch panel 106 and the customer facing display 110.

Upon completion of the sales data processing as described above, as Act 15, the processor 101 checks whether or not the next commodity registration is performed. If the next commodity registration is not performed (NO in Act 15), as Act 16, the processor 101 determines whether or not the settlement key K6 is input. If the settlement key K6 is not input (NO in Act 16), the processor 101 checks again whether or not the next commodity registration is performed. Here, by the processing items in Act 15 and Act 16, the processor 101 waits for the next commodity registration to be performed or the settlement key K6 to be input.

When the next commodity registration (PLU registration or category registration) is performed (YES in Act 15), the processor 101 returns to Act 6. At this time, the processor 101 clears the candidate memory 132, the registration memory, and the comparison memory. Then, the processor 101 performs the processing items in Act 6 to Act 14 in the same manner as described above.

Here, the processor 101 functions as an input means by performing the processing items in Act 1 or Act 15 in cooperation with the input device such as the scanner 108 or the keyboard 107.

In a waiting state in Act 15 and Act 16, if the settlement key K6 is detected to be input (YES in Act 16), as Act 17, the processor 101 performs registration settlement processing. For example, in a case of the cash settlement, the amount input by the numeric key K1 and the amount key K5 is taken as the deposit amount, and a change amount is calculated by subtracting the total amount of money stored in the total area 131B of the transaction memory 131 from the deposit amount, that is, so-called registration settlement processing for the cash settlement is performed. In addition to the cash settlement, such registration settlement processing also includes registration settlement processing for the credit settlement, the registration settlement processing for the cash voucher settlement, and the like. Any of these processing content items are well-known, and here the description thereof will be omitted.

When the registration settlement processing is completed, as Act 18, the processor 101 generates the receipt data based on the data stored in the transaction memory 131. Then, the processor 101 controls the printer 109 to print the receipt.

In addition, as Act 19, the processor 101 determines whether or not the transaction is a membership transaction. If a membership ID is stored in the membership ID memory, the processor 101 determines that the transaction is the membership transaction (YES in Act 19). As Act 20, the processor 101 updates the purchase history. That is, the processor 101 generates the purchase history data for each commodity in the data stored in the transaction memory 131. Then, the processor 101 searches the purchase history master 124 with the membership ID stored in the membership ID memory, and adds the purchase history data of the commodity to the history records 124R corresponding to the same membership ID.

If the membership ID is not stored in the membership ID memory, that is, the transaction is not the membership transaction (NO in Act 19), the processor 101 does not perform the processing in Act 20.

As Act 21, the processor 101 performs transmission of the transaction data. That is, the processor 101 creates the transaction data using the transaction ID stored in the transaction ID memory and the data stored in the transaction memory 131. Then, the processor 101 controls the communication interface 104 so as to transmit and output the transaction data to the store server.

Here, the processor 101 functions as an output means by performing the processing in Act 18 or Act 21 in cooperation with the printer 109 or the communication interface 104.

As above, the processor 101 ends the processing for the commercial transaction with the customer. Thereafter, the processor 101 restarts the processing items from Act 1 in order to control the commercial transaction with the next customer.

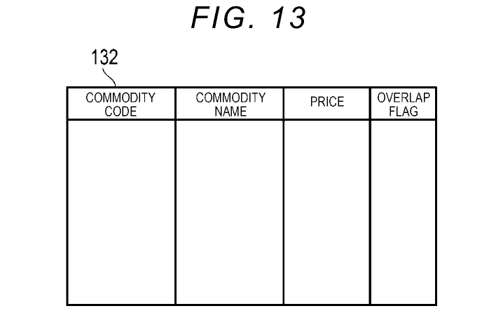

FIG. 12 illustrates an example of the receipt issued in the processing in Act 18. In FIG. 12, a receipt R1 is an example of issuing the receipt when the estimation mode is invalid, and a receipt R2 is an example of issuing the receipt when the estimation mode is valid. In either case, it is assumed that a customer purchases a “ham” as a commodity with a barcode attached and purchases an “apple (Fuji)” as a commodity without a barcode attached.

If the “ham” is registered, the cashier causes the scanner 108 to read the barcode of the “ham”. Then, the commodity code “123460”, the name “ham”, the price “200 yen”, the quantity “1”, and the amount of money “200 yen” are stored in the transaction memory 131.

If the “apple (Fuji)” is registered, the cashier operates the keyboard 107 and inputs the category code “fruit” and the price “100 yen”. At this time, if the estimation mode is invalid, the category code “1” of the “apple (Fuji)”, the category name “fruit”, the price “100 yen”, the quantity “1”, and the amount of money “100 yen” are stored in the transaction memory 131. At this stage, if the settlement key is operated, the receipt R1 is issued. In addition, the transaction data created based on the data in the transaction memory 131 is transmitted to the store server. As a result thereof, the sales of “ham” which is registered in the PLU basis is managed on a specific item basis. In contrast, the sales of “apple (Fuji)” which is registered in the category basis is managed on a category basis of “fruit”.

On the other hand, if the estimation mode is valid, the commodity estimation processing is performed. Here, it is assumed that four items of an “apple (Orin)”, an “apple (Fuji)”, a “pear (Hosui)”, and a “grapefruit” are in the commodity master 121 as the commodity of which the category code is “1” and the price is “100 yen”. In that case, at the stage of completing the search of the commodity master 121 by the processing items in Act 32 to Act 36, the data corresponding to the above four items are stored in the candidate memory 132. Therefore, since the number of candidates is “4”, the candidate narrow-down processing is performed.

Then, the cashier puts the “apple (Fuji)” to the imaging area of the camera 112. Then, the similarity R is calculated in the item basis from the appearance feature value of the commodity obtainable from the image obtained by imaging the “apple (Fuji)” and the appearance feature value data of each item the “apple (Orin)”, the “apple (Fuji)”, the “pear (Hosui)” and the “grapefruit”. Here, it is assumed that the similarity R for the three items of the “apple (Orin)”, the “apple (Fuji)” and the “pear (Hosui)” is equal to or greater than the threshold value, but the similarity R of only the “grapefruit” is smaller than the threshold value. In that case, the data of the “grapefruit” is deleted from the candidate memory 132. Then, the selection screen SC1 illustrated in FIG. 11 is displayed on the touch panel 106.

The cashier who checked the selection screen SC1 touches the area A22 where the “apple (Fuji)” is displayed. Then, the commodity code “123456” of the “apple (Fuji)”, the name “apple (Fuji)”, the price “100 yen”, the quantity “1”, the amount of money “100 yen” are stored in the transaction memory 131.

At this stage, if the settlement key is operated, the receipt R2 is issued. In addition, the transaction data created based on the data in the transaction memory 131 is transmitted to the store server. As a result thereof, the sales of the “ham” which is registered in the PLU basis is managed on the specific item basis. In addition, the sales of the “apple (Fuji)” which is registered in the category basis is also managed on the specific item basis.

By the way, when the customer is the member, the cashier inputs the membership ID received from the member to the POS terminal 100. In this way, the purchase history data of the “ham” and the “apple (Fuji)” are stored in the purchase history master 124 in association with the customer's membership ID.

As described above, according to the present embodiment, by making the estimation mode valid, the sales of the commodity registered on the category registration basis can be managed in the items basis sales instead of in the category basis sales by inputting the category code and the price. As a result thereof, the commodity purchase data can be analyzed in more detail.

In addition, in the receipt R1 when the estimation mode is invalid, the commodity which is registered in the category basis, for example, the name of “apple (Fuji)” is printed with the category name “fruit”, whereas in the receipt R2 when the estimation mode is valid, the name is printed with the commodity name “apple (Fuji)”. Therefore, by making the estimation mode valid, it is possible to print the specific commodity name on the receipt even for the commodities which had to be registered in the category registration basis. As a result, the customer who checks the receipt R2 can know the commodity name for the commodities registered in the category registration basis as well as the commodities registered in the PLU registration basis. In addition, the names displayed on the touch panel 106 and the customer facing display 110 are also displayed as the commodity name instead of the category name, and thus, it can be easily determined which commodity is registered.

Incidentally, in the present embodiment, the commodity that belongs to the same category as the commodity registered in the category basis and of which the price is the same is assumed to be the primary candidate commodity. The similarity between the appearance feature value obtainable from the image of the commodity registered in the category basis and the feature value data preset for the primary candidate commodity is obtained, and then, the commodity having the similarity equal to or greater than the predetermined threshold value is displayed on the selection screen SC1 as the final candidate commodity. Therefore, the candidate commodity displayed on the selection screen SC1 is narrowed down to only the commodity of which the appearance feature is similar to the commodity registered in the category basis among the commodities of the same category and the same price, therefore, the commodities of which the appearance features are not similar will not be displayed on the selection screen SC1 as the candidate commodity. Generally, it is considered that the commodities of which the appearance features are not similar cannot be assumed to be the commodity registered in the category basis, therefore, the candidate commodity can effectively be narrowed down.

In addition, if the estimation mode is invalid, the commodity estimation processing is canceled. If the commodity estimation processing is performed, usually there occurs an operation of selecting the corresponding commodity from the selection screen SC1, and thus, it takes time to perform the processing. Therefore, at times such as the early evening when the cash register is very busy, by invalidating the estimation mode, it is possible to alleviate congestion at the cash register.

### Second Embodiment

Next, the second embodiment will be described.

In the second embodiment, the camera 112 can be omitted from the POS terminal 100. In addition, the recognition dictionary master 123 is not necessary, either. Other configuration elements illustrated in FIG. 1 are the same as that in the first embodiment. However, a data structure of the data in the candidate memory 132 is different.

FIG. 13 illustrates the data structure of the data in the candidate memory 132 in the second embodiment. As illustrated in FIG. 13, the candidate memory 132 includes an area for storing an overlap flag in addition to the commodity code, the commodity name and the price of the candidate commodity. The overlap flag will be described later.

In the second embodiment, the operation of the POS terminal 100 differs from that in the first embodiment in the candidate narrow-down processing. The other operations of the POS terminal 100 described referring to FIG. 8 and FIG. 9 are the same as that in the first embodiment, so the description thereof will be omitted here.

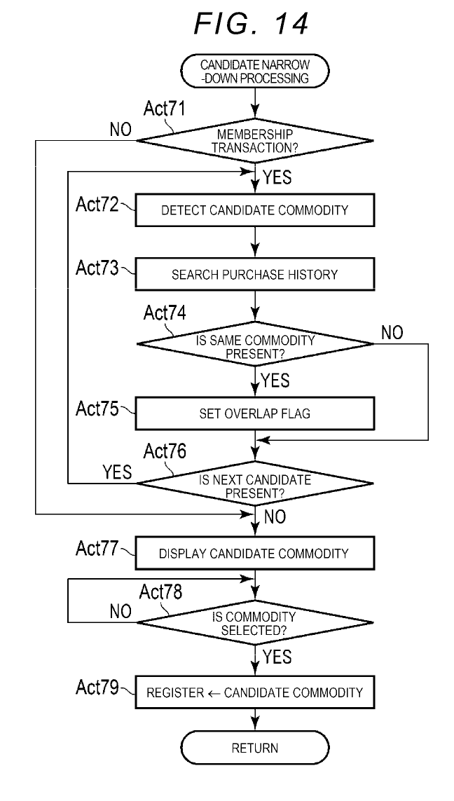

In Act 38 in the commodity estimation processing (refer to FIG. 9), the processor 101 of the POS terminal 100 enters the candidate narrow-down processing illustrated in the flowchart in FIG. 14 when two or more data items are stored in the candidate memory 132. The content of the processing illustrated in FIG. 14 and described below are just examples. The processing order and the processing content are not particularly limited as long as the same result can be obtained.

First, as Act 71, the processor 101 determines whether or not the transaction is the membership transaction. If the membership ID is stored in the membership ID memory, the processor 101 determines that the transaction is the membership transaction (YES in Act 71). As Act 72, the processor 101 detects one commodity code from the candidate commodity data stored in the candidate memory 132.

As Act 73, the processor 101 searches the purchase history master 124 with the membership ID stored in the membership ID memory. As Act 74, the processor 101 checks whether or not the purchase history data of the commodity code detected in Act 72 is present in the history records 124R which is associated with the membership ID. If the purchase history data is present in the history records 124R (YES in Act 74), as Act 75, the processor 101 sets the overlap flag on the data that is associated with the commodity code among the data of the candidate commodity stored in the candidate memory 132. If the purchase history data is not present in the history records 124R (NO in Act 74), the processor 101 does not set the overlap flag.

Thereafter, as Act 76, the processor 101 checks whether or not the commodity code which is not detected yet is present in the candidate memory 132. If the undetected commodity code is present (YES in Act 76), the processor 101 returns to Act 72. That is, the processor 101 detects one undetected commodity code from the candidate commodity data stored in the candidate memory 132. Then, the processor 101 performs the processing items in Act 73 to Act 75 in the same manner as described above.

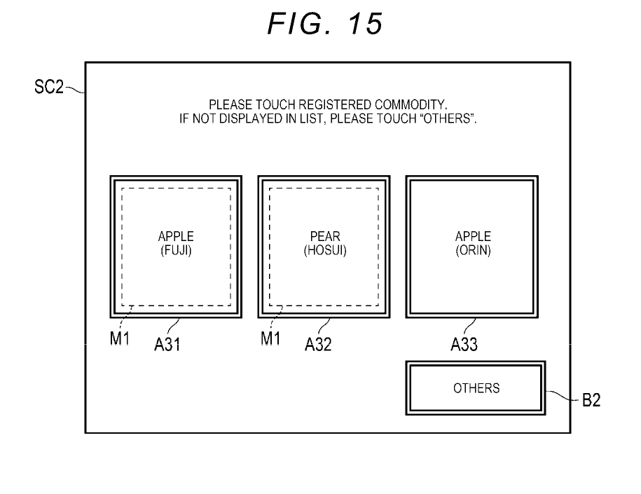

In Act 76, if it is determined that the undetected commodity code is not present in the candidate memory 132 (NO in Act 76), as Act 77, the processor 101 displays the selection screen SC2 (refer to FIG. 15) for the candidate commodity on the touch panel 106 based on the data stored in the candidate memory 132. In addition, in Act 71, if it is determined that the transaction is not the membership transaction (NO in Act 71), the processor 101 proceeds to the processing in Act 77 without performing the processing items in Act 72 to Act 76, and displays the selection screen SC2 for the candidate commodity on the touch panel 106.

An example of the selection screen SC2 is illustrated in FIG. 15. As illustrated in FIG. 15, the selection screen SC2 displays display areas A31, A32, and A33 of the candidate commodities and an “others” button B2. The commodity names of the candidate commodities are displayed on the display areas A31, A32, and A33. The candidate commodity is the commodity specified by the commodity code stored in the candidate memory 132. The commodity name is stored in the candidate memory 132. The processor 101 sequentially reads the commodity names stored in the candidate memory 132 and displays the names on the display areas A31, A32, and A33.

At this time, the processor 101 preferentially displays the commodity name of the data for which the overlap flag is set on the display areas A31, A32, and A33. An identification mark M1 is displayed in the display areas (display area A31 and the display area A32 in FIG. 15) displaying the commodity name of the data for which the overlap flag is set.

In the display example in FIG. 15, the identification mark M1 is a frame of a dashed line, but the type of the identification mark M1 is not particularly limited. In addition, instead of displaying the identification mark M1, the background color of the display area displaying the commodity name of the data for which the overlap flag is set may be changed, or the commodity name may be blinkingly displayed. The point is that the cashier can distinguish between the commodity for which the overlap flag is set, that is, candidate commodity having the purchase history among the candidate commodities, and the commodity for which the overlap flag is reset, that is, the commodity having no purchase history.

The cashier who checks the selection screen SC2 performs a touching operation on the display area A31, A32 or A33 in which the commodity name of the commodity registered in the category basis is displayed.

The processor 101 waits for the touching operation of the area A31, A32 or A33 as Act 78. If the touching operation is performed on the area A31, A32 or A33, as Act 79, the processor 101 writes the commodity code, the commodity name and the price of the commodity of which the commodity name is displayed in the area A31, A32 or A33 into the registration memory. The commodity name and the price are data stored in the candidate memory 132 in association with the commodity code. That is, the processor 101 writes the commodity code, the commodity name and the price of the candidate commodity selected from the plurality of candidate commodities into the registration memory. As described above, the processor 101 ends the candidate narrow-down processing.

In the second embodiment operating in this manner, by making the estimation mode valid, the sales of the commodity registered in the category basis can be managed in the item basis sales instead of in the category basis sales by inputting the category code and the price. In addition, the name displayed on the touch panel 106 and the customer facing display 110 and the name printed on receipt can also be displayed or printed with the commodity name instead of the category name.

In addition, in the second embodiment, among the primary candidate commodities of which the category and the price match the commodity registered in the category basis, the commodity having the purchase history is preferentially displayed on the selection screen SC2. It is a common event that the same customer repeatedly purchases the same commodity. Therefore, by preferentially displaying the commodity having the purchase history on selection screen SC2, there is an advantage that the cashier makes it easier to find the commodity that is registered in the category basis from the selection screen SC2.

The embodiments described above can be modified as follows.

In the embodiments described above, the estimation mode can be set to be valid or invalid, and when the mode is invalid, the processing items in Act 11 and Act 12 in FIG. 8 are performed. In another embodiment, the estimation mode may be omitted. In other words, in Act 6 in FIG. 8, if it is determined that the commodity is registered on the category registration basis, the process may proceed to Act 13 and the commodity estimation processing may be performed.

In the embodiments described above, in the commodity estimation processing, the commodity of which the category code and the price match the commodity registered in the category basis is stored in candidate memory 132 as the candidate commodity. In another embodiment, the commodity of which the category code matches but the price does not match within an allowable range may also be stored in candidate memory 132 as the candidate commodity. In a case of the commodity without the barcode attached, the price may change due to the size and the weight thereof. Even in this case, it is possible to improve an accuracy of detecting the candidate commodity by setting the commodity of which the price does not match within the allowable range as the candidate commodity.

In the first embodiment, as the commodity narrow-down processing, the feature value of the commodity to be registered is obtained from the image of the commodity to be registered, the feature value of the candidate commodity is detected from the feature value storage unit that stores the basic feature value for each commodity and the similarity with the feature value of the commodity to be registered is obtained, and then, the narrow-down is performed by choosing the candidate commodity having the similarity equal to or greater than the predetermined threshold value. As another commodity narrow-down processing, a method of narrowing the commodity down using the principle of Hough transform known as a method of detecting an object from an image can be considered.

In addition, a method of narrowing down by detecting the components of the commodity with a molecular sensor using a spectrometer, or a method of narrowing down the commodity by analyzing the commodity using a 3D scanner can be considered.

In the second embodiment, the commodity having the purchase history is searched for from among the candidate commodities detected in the commodity estimation processing, and the commodity having the purchase history is displayed on the selection screen SC2 so as to be distinguished from the commodity having no purchase history. In another embodiment, first, only the candidate commodity having the purchase history is displayed on the selection screen SC2, and if the commodity registered on the category registration basis is not fixed, the candidate commodities having no purchase history may be displayed on the selection screen SC2. Incidentally, regarding a searching range of purchase history, it is not necessary to search all the purchase history records stored in the purchase history master 124. For example, the purchase history records may be searched by setting a period of one year or the past six months.

Implementation of the commodity registration device is generally performed using a program such as the commodity registration program stored in the main memory or the auxiliary memory device. However, without being limited to this, this kind of program may be transferred in a state of not being stored in the main memory or the like. In this case, a control program or the like transferred separately from the commodity registration device may be written into the writable memory device included in the commodity registration device according to the operation by the user, or the separated control program described above maybe rewritten. The transfer of the commodity registration program and the like can be performed by recording in a removable recording medium or by communication via the network. The recording medium may be in any form such as a CD-ROM and a memory card as long as the program can be stored, and can be read by the device. In addition, the function obtained by installing or downloading the program may be realized by the function in cooperation with an operating system (OS) or the like inside the device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A point-of-sale (POS) terminal comprising:
a storage device that stores, in association for each of a plurality of commodities that may be registered, a commodity code unique to the commodity, a commodity name, a price of the commodity, and a commodity classification to which the commodity belongs;
an input device for receiving input of a commodity classification to which a commodity to be registered in a transaction belongs and a price of the commodity; and
a processor programmed to perform:
a category-based commodity registration processing including:
searching the storage device based on the commodity classification and the price input via the input device,
determining at least one candidate commodity based on the search, and
registering the commodity to be registered in the transaction based on the commodity code stored in association of a selected one of the at least one determined candidate commodities, and
a settlement processing to settle the transaction based on the price associated with each commodity code of the commodity registered in connection with the transaction.

2. The POS terminal according to claim 1, wherein, if a plurality of candidate commodities are determined based on the search, the processor is further configured to perform a candidate narrow-down processing to select the commodity to be registered out of the plurality of candidate commodities.

3. The POS terminal according to claim 2, further comprising:
a camera configured to generate an image of the commodity to be registered, wherein
the candidate narrow-down processing includes:
generating, with the camera, an image of the commodity to be registered,
extracting a feature value of the commodity to be registered from the generated image,
calculating a similarity ratio of the commodity to be registered compared to each commodity that may be registered based on the extracted feature value, and
selecting the commodity to be registered as one of the commodities that may be registered if the corresponding calculated similarity ratio exceeds a predetermined threshold.

4. The POS terminal according to claim 3, further comprising:
a display device, wherein
if the calculated similarity ratio corresponding to a plurality of the commodities that may be registered exceeds the predetermined threshold, the narrow-down processing further includes:
controlling the display device to display the plurality of commodities that may be registered for which the corresponding calculated similarity ratio exceeds the predetermined threshold, and
accepting, via the input device, a selection of one of the displayed plurality of commodities as the commodity to be registered.

5. The POS terminal according to claim 2, wherein the candidate narrow-down processing includes:
retrieving a transaction history of a member corresponding to a membership ID received by the input device,
determining whether a commodity code included in the transaction history corresponds to the input commodity classification, and
selecting the commodity to be registered as one of at least one commodity for which the corresponding commodity code is included in the retrieved transaction history that corresponds to the input commodity classification.

6. The POS terminal according to claim 5, further comprising:
a display device, wherein
if there are a plurality of commodities for which the corresponding commodity code included in the retrieved transaction history corresponds to the input commodity classification, the narrow-down processing further includes:
controlling the display device to display the plurality of commodities for which the corresponding commodity code included in the retrieved transaction history corresponds to the input commodity classification, and
accepting, via the input device, a selection of one of the displayed plurality of commodities as the commodity to be registered.

7. The POS terminal according to claim 6, wherein the displayed plurality of commodities for which the corresponding commodity code included in the retrieved transaction history corresponds to the input commodity classification are displayed in a manner distinguished from commodities for which the corresponding commodity code is not included in the retrieved transaction history.

8. The POS terminal according to claim 1, further comprising:
a scanner configured to scan a barcode on the commodity to be registered, wherein
the processor is further programmed to perform a PLU-based commodity registration processing including:
determining the commodity code of the commodity to be registered based on the scanned barcode, and
registering the commodity to be registered in the transaction based on the determined commodity code.

9. The POS terminal according to claim 8, wherein the processor is further configured to:
transmit to a server transaction details for the transaction, including the commodity code for each commodity registered according to the PLU-based commodity registration processing and the category-based commodity registration processing.

10. The POS terminal according to claim 1, wherein, if no candidate commodity can be identified based on the search, the processor registers the commodity based on the commodity classification and the price input via the input device.

11. A commodity registration method comprising:
storing, in association for each of a plurality of commodities that may be registered, a commodity code unique to the commodity, a commodity name, a price of the commodity, and a commodity classification to which the commodity belongs;
receiving input of a commodity classification to which a commodity to be registered in a transaction belongs and a price of the commodity; and
performing a category-based commodity registration processing including:
searching the storage device based on the commodity classification and the price input via the input device,
determining at least one candidate commodity based on the search, and
registering the commodity to be registered in the transaction based on the commodity code stored in association of a selected one of the at least one determined candidate commodities; and
performing a settlement processing to settle the transaction based on the price associated with each commodity code of the commodity registered in connection with the transaction.

12. The method according to claim 11, further comprising:
if a plurality of candidate commodities are determined based on the search, performing a candidate narrow-down processing to select the commodity to be registered out of the more than one candidate commodities.

13. The method according to claim 12, wherein the candidate narrow-down processing includes:
generating an image of the commodity to be registered,
extracting a feature value of the commodity to be registered from the generated image,
calculating a similarity ratio of the commodity to be registered compared to each commodity that may be registered based on the extracted feature value, and
selecting the commodity to be registered as one of the commodities that may be registered if the corresponding calculated similarity ratio exceeds a predetermined threshold.

14. The method according to claim 13, wherein, if the calculated similarity ratio corresponding to a plurality of the commodities that may be registered exceeds the predetermined threshold, the narrow-down processing further includes:
controlling a display device to display the plurality of commodities that may be registered for which the corresponding calculated similarity ratio exceeds the predetermined threshold, and
accepting a selection of one of the displayed plurality of commodities as the commodity to be registered.

15. The method according to claim 12, wherein the candidate narrow-down processing includes:
retrieving a transaction history of a member corresponding to a membership ID received by the input device,
determining whether a commodity code included in the transaction history corresponds to the input commodity classification, and
selecting the commodity to be registered as one of at least one commodity for which the corresponding commodity code is included in the retrieved transaction history that corresponds to the input commodity classification.

16. The method according to claim 15, wherein, if there are a plurality of commodities for which the corresponding commodity code included in the retrieved transaction history corresponds to the input commodity classification, the narrow-down processing further includes:
controlling a display device to display the plurality of commodities for which the corresponding commodity code included in the retrieved transaction history corresponds to the input commodity classification, and
accepting, via the input device, a selection of one of the displayed plurality of commodities as the commodity to be registered.

17. The method according to claim 16, wherein the displayed plurality of commodities for which the corresponding commodity code included in the retrieved transaction history corresponds to the input commodity classification are displayed in a manner distinguished from commodities for which the corresponding commodity code is not included in the retrieved transaction history.

18. The method according to claim 11, further comprising:
performing a PLU-based commodity registration processing including:
scanning a barcode on the commodity to be registered,
determining the commodity code of the commodity to be registered based on the scanned barcode, and
registering the commodity to be registered in the transaction based on the determined commodity code.

19. The method according to claim 18, further comprising:
transmitting to a server transaction details for the transaction, including the commodity code for each commodity registered according to the PLU-based commodity registration processing and the category-based commodity registration processing.

20. The method according to claim 11, wherein the category-based commodity registration processing further includes:
if no candidate commodity can be identified based on the search, the commodity based on the commodity classification and the price input via the input device, registering the commodity based on the commodity classification and the price input via the input device.
